(19) United States
(12) Patent Application Publication
(10) Pub. No.: US 2005/0237006 A1
(43) Pub. Date: Oct. 27, 2005

(54) Light emitting apparatus

(76) Inventor: Chen-Ni Lee, Brisbane (AU)

Correspondence Address: BIRCH STEWART KOLASCH & BIRCH, PO BOX 747, FALLS CHURCH, VA, 22040-0747, US

(21) Appl. No.: 10/829,170

(22) Filed: Apr. 22, 2004

(51) Int. Cl. H05B 37/02

(52) U.S. Cl. 315/291; 315/149; 315/155

(57) ABSTRACT

A light emitting base. The light emitting base carries a solid material and comprises a base structure, at least one light emitting device, a control module and a power supply. The base structure is used for carrying a solid material and provided with at least one light emitting device. The control module is used to control patterns, amplitude and duration of the light emission pulses. The power supply provides electric power to the light emitting devices and the control module.

### BACKGROUND OF THE INVENTION

1. Field of the Invention

The present invention relates to a light emitting apparatus, and specifically to a light emitting apparatus with a sensor to detect physical changes of environment.

2. Description of the Related Art

Light emitting diodes(LEDs) are widely used to decorate different diviceses. If a device is provided with a light emitting diode, a user can easily identify the location of the device. Moreover, the light emitting diode can increase diversity of visual perception. Monotony can be eliminated through changes of visual effects and the apparatus looks more tasteful.

However, just making the light emitting diode on the apparatus emit light pulses still seems a little monotonous. If the pattern, amplitude and duration of individual light pulses can be controlled by preference, more diverse visual effects can be achieved.

### SUMMARY OF THE INVENTION

The present invention provides a light emitting base for carrying a solid material. The light emitting base comprises a base structure, at least one light emitting device on the base structure, a control module and a power supply. The base structure carries the solid material and is provided with at least one light emitting device. The control module controls patterns, amplitude and duration of emitted light pulses. The power supply provides electric power to the light emitting devices and the control module.

The present invention also provides a light emitting container for carrying a fluid material. The light emitting container comprises a hollow structure, at least one light emitting device, a control module and a power supply. The hollow structure carries the fluid material and is provided with at least one light emitting device. The control module controls patterns, amplitude and duration of the light emission pulses. Power is supplied to the light emitting devices and the control module by the power supply.

The present invention also provides a light emitting belt for binding a solid material. The light emitting belt comprises a belt structure, at least one light emitting device, a control module and a power supply. The belt structure is used to bind the solid material and is provided with at least one light emitting device. The control module is used to control the patterns, amplitude and duration of the light emission pulses. The light emitting devices and the control module are powered by the power supply.

### BRIEF DESCRIPTION OF THE DRAWINGS

The present invention can be more fully understood by reading the subsequent detailed description in conjunction with the examples and references made to the accompanying drawings, wherein:

FIGS. 1A & 1B are illustrations of a light emitting base of an embodiment of the present invention.

FIGS. 2A & 2B are light emitting containers of another embodiment of the present invention.

FIG. 3 is a light emitting belt of another embodiment of the present invention.

### DETAILED DESCRIPTION OF THE INVENTION

Each light emitting base, container and belt according to the present invention is provided with at least one light emitting device. In the following embodiments, LED devices will be used to represent the light emitting devices. However, light emitting device is not limited thereto. The light emitting device can comprise other electroluminescent materials.

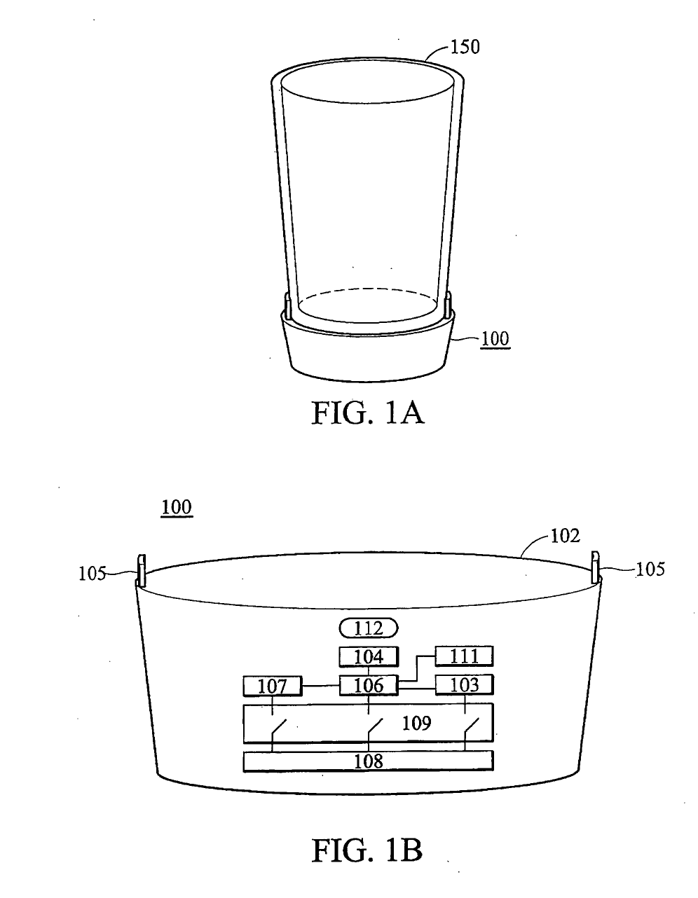

FIG. 1A shows a light emitting base 100 according to one embodiment of the present invention. It is required that the light emitting base 100 can carry a solid material 150, but the shape of the light emitting base 100 is not limited. As shown in FIG. 1B, the light emitting base 100 comprises a base structure 102, at least one LED device 104, a control module 106 and a power supply 108. The base structure 102 is used to carry the solid material 150 and is provided with at least one LED device 104. The solid material 150 can be a cellular phone, a telephone, a remote control for an electronic appliance, or any container, such as a glass or a bottle, and the like. The control module generates a control signal and thereby controls patterns, amplitude and duration of the light emission pulses of the LED device 104. The power supply 108 provides electrical power to the LED device 104 and the control module 106.

The light emitting base 100 further comprises a sensor 103. The sensor 103 is activated when electrical power is provided by the power supply 108. The sensor 103 detects physical changes of the surroundings and thereby generates a signal to the control module 106. The sensor 103 can be a sensor which detects temperature, pressure, sound or light. The sensor 103 can also be a sensor which responds to human biometric authentication, such as skin temperature, fingerprint, or voice. For example, when a solid material is put on the light emitting base 100, the sensor 103 detects the change in the pressure and generates a signal for the control module 106, by which the light pulses of the LED device 104 is controlled.

Additionally, the light emitting base 100 further comprises a fixture 105 restraining the carried solid material 105 to prevent movement thereof. The fixture can be a fastener, a suction pad, and the like.

Furthermore, the light emitting base 100 comprises a timer 107. The timer 107 is powered by the power supply 108 and to measure duration of light emission pulses. The timer 107 generates a timing signal for the control module 106 and thereby duration of light pulses emitted by the LED device 104 are controlled.

The light emitting base 100 further comprises a switch 109. The switch 109 controls whether the power supply provides electrical power to the electronic components, such as the sensor 103, the LED device 104, the control module 106 and the timer 107, on the light emitting base 100. When the switch 109 is turned off, the power supply 108 stops providing electrical power to the electronic components on the light emitting base 100. Thus, power dissipation caused by standby currents of the electronic components can be eliminated.

The light emitting base 100 also comprises a mode option 111, by which a user can select a light emitting mode. A selection signal is fed back to the control module 106 and patterns, amplitude, and duration of the light emission pulses are thereby controlled. The mode option 111 can be a knob. The light emitting base 100 can also be divided into two sections, one of which can be rotated to act as the mode option 111. The patterns include different colors generated by different LED devices, the fonts displayed by a LED array, and the like.

The light emitting base 100 comprises an optical component 112 to transform the light generated by the LED devices 104 and display a specific pattern. The optical component 112 can be a lens, a prism, or an optical design, such as a diamond, with multiple total reflections inside. The optical component 112 can also be printed or etched with text or a pattern, such as a company logo recognizable when light is emitted therethrough.

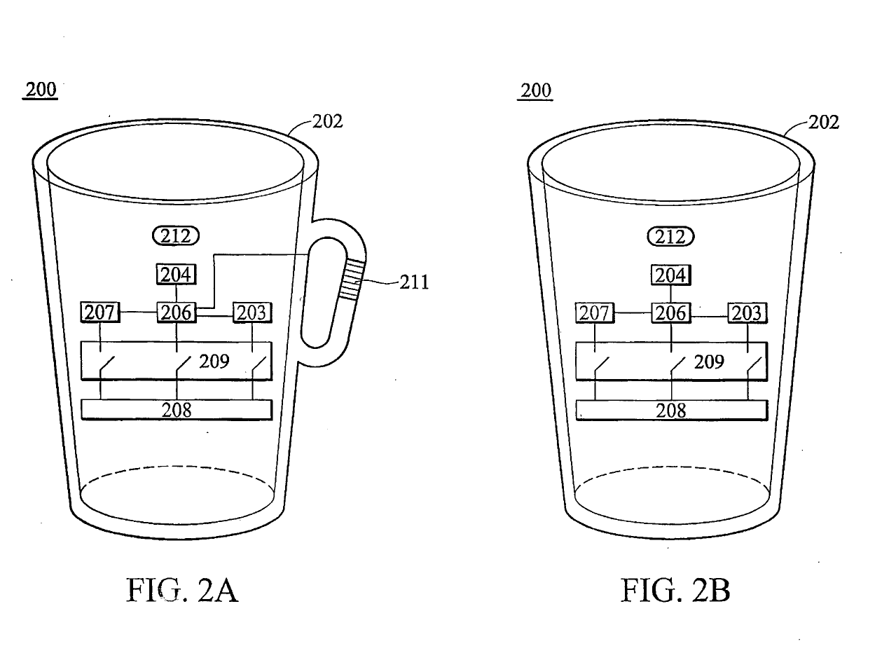

FIGS. 2A & 2B show light emitting containers, such as a glass or a bottle, of another embodiment according to the present invention. The components of the light emitting container are the same as the mentioned light emitting base, except that the container is used to carry a fluid material. For example, a sensor on the container can generate an indication signal for the control module when the container is loaded with a certain amount of fluid so that the patterns of emitted light can be controlled. In addition, the sensor on the container can detect a collision and generate an indication signal when the container makes contact with another container. The indication signal can be transmitted to the control module and the LED devices and thereby emit light.

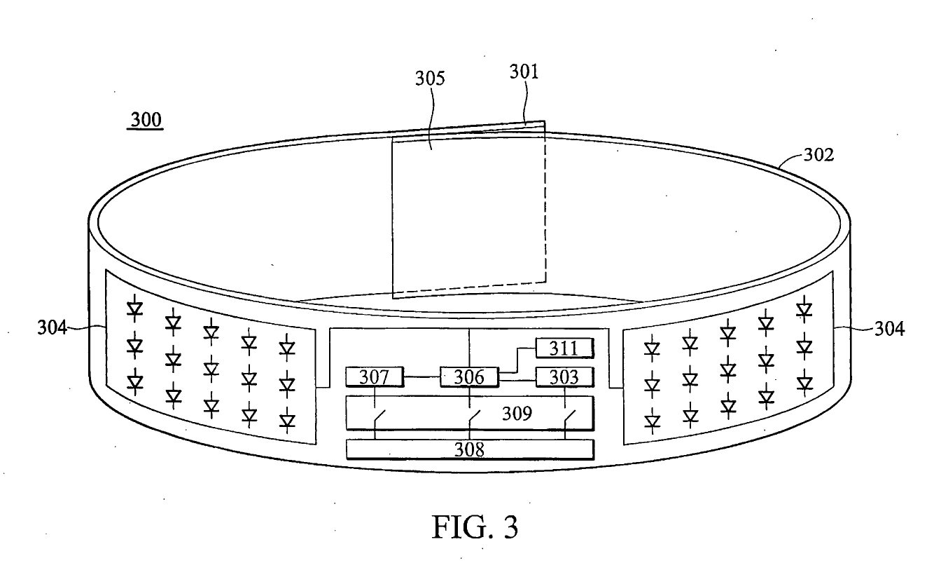

Please refer to FIG. 3, a light emitting belt 300 of another embodiment of the present invention is shown. The light emitting belt 300 comprises a belt structure 302, at least one LED device 304, a control module 306 and a power supply 308. The belt structure 302, for binding a solid material, can be a wristband, a headband, a chain, a necklace, a waistband, a ring or the like. The belt structure 302 is provided with at least one LED device 304. The control module 306 generates a control signal and thereby controls patterns, amplitude and duration of the light emission pulses of the LED device 304. The power supply 308 provides electrical power to the LED device 304 and the control module 306.

The light emitting belt 300 further comprises a sensor 303. The sensor 303 utilizes the electrical power provided by the power supply 308. The sensor 303 detects physical changes of the surroundings and thereby generates a signal to the control module 306. The sensor 303 can be a sensor which detects temperature, pressure, sound, or light. The sensor can also be a sensor which responds to human biometric authentication, such as skin temperature, fingerprint, or voice. For example, when the light emitting belt 302 is worn on the head, the sensor 303 can detect the temperature variation of the forehead and generate an indication signal to the control module 306 controlling the light emission of the LED devices 304. For another example, the light emitting belt 300 is an accessory for a cellular phone. When the cellular phone starts ringing, the sensor 303 can detect the incoming signal and generate an indication signal to the control module 306.

Furthermore, the light emitting belt 300 comprises a timer 307. The timer 307 is powered by the power supply 308 and used to measure duration of light emission pulses. The timer 307 generates a timing signal for the control module 306 and thereby duration of the LED device 304 is controlled.

The light emitting base 300 further comprises a switch 309. The switch 309 controls whether the power supply provides electrical power to the electronic components, such as the sensor 303, the LED device 304, the control module 306 and the timer 307, on the light emitting base 300. The switch 309 can be turned on by connecting a first end 301 and a second end 305 of the belt structure 302. The power supply 308 thereby supplies electrical power to the electronic components on the base 300.

The light emitting belt 300 also comprises a mode option 311, by which a user can select a light emitting mode he wants. A selection signal is fed back to the control module 306 and patterns, amplitude, and duration of the light emission pulses are thereby controlled.

In the light emitting base, container and belt provided by the present invention, a sensor can detect physical changes of surroundings and generate an indication signal for the control module to manipulate patterns, amplitude and duration of the light emission pulses. Thus relatively more and different visual effects can be generated. Furthermore, a timer can be included to increase pattern variety of light emission. In addition, a mode option is provided for selection of desired patterns. Moreover, the addition of a switch can eliminate power consumption caused by standby current of the electronic components.

Finally, while the invention has been described by way of example and in terms of the above, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A light emitting base, comprising:
a base structure for carrying a solid material;
at least one light emitting device on the base structure;
a control module for generating a control signal to manipulate patterns, amplitude and duration of the light emitting devices; and
a power supply for providing electrical power to the light emitting devices.

2. The light emitting base as claimed in claim 1, wherein the solid material is a container.

3. The light emitting base as claimed in claim 1, further comprising a sensor to detect physical changes of the surroundings and generate an indicating signal for the control module.

4. The light emitting base as claimed in claim 3, further comprising a fixture to make the solid material fixed on the light emitting base.

5. The light emitting base as claimed in claim 3, further comprising a mode option to allow users to select a light emitting mode and feedback a selection signal to the control module.

6. The light emitting base as claimed in claim 3, further comprising a timer to measure duration of the light emitting device and transmit a timing signal to the control module.

7. The light emitting base as claimed in claim 3, further comprising a switch for controlling whether electrical power is supplied to the light emitting device, the sensor and the control module.

8. The light emitting base as claimed in claim 3, further comprising an optical component to transform the light generated by the LED devices and display a specific pattern.

9. A light emitting container, comprising:
a hollow structure for carrying a material;
at least one light emitting device on the hollow structure;
a control module for generating a control signal to manipulate patterns, amplitude and durations of the light emitting devices; and
a power supply for supplying electrical power to the light emitting devices.

10. The light emitting container as claimed in claim 9, further comprising a sensor to detect physical changes of the surroundings and generate an indication signal for the control module.

11. The light emitting container as claimed in claim 10, further comprising a mode option to allow selection of a light emitting mode and feedback a selection signal to the control module.

12. The light emitting container as claimed in claim 10, further comprising a timer to measure duration of the light emitting device and transmit a timing signal to the control module.

13. The light emitting container as claimed in claim 10, further comprising a switch for controlling whether electrical power is supplied to the light emitting device, the sensor and the control module.

14. The light emitting container as claimed in claim 10, further comprising an optical component to transform the light generated by the LED devices and display a specific pattern.

15. A light emitting belt, comprising:
a belt structure for binding a material;
at least one light emitting device on the belt structure;
a control module for generating a control signal to manipulate patterns, amplitude and duration of the light emitting devices; and
a power supply for supplying electrical power to the light emitting devices.

16. The light emitting belt as claimed in claim 15, further comprising a sensor to detect physical changes of the surroundings and generate an indication signal for the control module.

17. The light emitting belt as claimed in claim 16, further comprising a mode option to allow users to select a light emitting mode and feedback a selection signal to the control module.

18. The light emitting belt as claimed in claim 16, further comprising a timer to measure duration of the light emitting device and transmit a timing signal to the control module.

19. The light emitting belt as claimed in claim 16, further comprising an optical component to transform the light generated by the LED devices and display a specific pattern.

20. The light emitting belt as claimed in claim 16, further comprising a switch for controlling whether electrical power is supplied to the light emitting device, the sensor and the control module.

21. The light emitting belt as claimed in claim 20, the switch can be turned on by connecting a first end and a second end of the belt structure and electrical power is thereby provided to the light emitting device and the control module.
